(19) United States
(12) Patent Application Publication
(10) Pub. No.: US 2010/0071503 A1
(43) Pub. Date: Mar. 25, 2010

(54) Adjustable Arc Cam

(75) Inventors: John Tobin, Crestline, CA (US); John T. Mizulo, Palm Desert, CA (US); Christopher S. Shaw, Moreno Valley, CA (US); Albert W. Shaw, Stuart, FL (US)

Correspondence Address: VIDAS, ARRETT & STEINKRAUS, P.A., SUITE 400, 6640 SHADY OAK ROAD, EDEN PRAIRIE, MN, 55344, US

(73) Assignee: TOBIN MANUFACTURING, LLC, Redlands, CA (US)

(21) Appl. No.: 12/236,101

(22) Filed: Sep. 23, 2008

(51) Int. Cl. F16H 53/04

(52) U.S. Cl. 74/568 R

(57) ABSTRACT

The present invention is directed toward a cam assembly comprising a cam, a drive shaft and an adjustable screw. The cam includes a first side, a second side opposite the first side, an outer perimeter and a thickness between the first and second sides. The cam further has a first elongated bore through the first and second sides and the thickness of the cam, wherein the first elongated bore has a length radially oriented in the cam and a first end and a second end. The cam further has an elongated threaded hole extending from the outer perimeter to and being in communication with the first elongated bore. The drive shaft extends through the first elongated bore. The adjustment screw is within the elongated threaded hole and is engaged with the drive shaft, wherein the cam assembly is constructed and arranged such the drive shaft can be adjustably positioned and fixedly secured relative to the cam at a plurality of positions along the length of the first elongated bore.

### CROSS-REFERENCE TO RELATED APPLICATIONS

Not Applicable

### FIELD OF THE INVENTION

This invention in general relates to cam assemblies. More particularly to generally circular cams mounted on drive shafts wherein the arc of each of the cams is adjustable.

### BACKGROUND OF THE INVENTION

As is well known, a cam is a projecting part of a rotating wheel or shaft that strikes a lever at one or more points on its circular path. The cam can be a simple tooth or an eccentric disc or other shape that produces a smooth reciprocating motion in a follower which is a lever making contact with the cam. The cam can be seen as a device that translates movement from circular to reciprocating or sometimes oscillating.

Single cams and linear alignments of a plurality of interconnected cams are known and have been in wide use. Examples of machines which use such cam arrangements include machines to meter, mix and dispense substances. These machines utilize piston pumps to meter plural component, reactive liquids. The piston pumps are powered either directly by an air piston motor through connecting rods and fulcrum or by an electric motor driven shaft connected to a cam or cams Electric motor driven cams have been used for many years to reciprocate pumps in single or two component spray paint machines. However, utilizing multiple cams does not provide a means to infinitely vary the metering ratio of the two reactive liquids. Varying the ratio is needed to compensate for effects of different working conditions or when a different chemical system with a different ratio is required. The only method known is to exchange one of the cams for another cam made with a different hub location to produce a different arc and piston stroke, thereby providing a new fixed ratio. There remains a need for a system in which the effective arc of the individual cams can be changed without having to individually replace them in order to provide for a new fixed ratio.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

### BRIEF SUMMARY OF THE INVENTION

In some embodiments, the invention provides adjustable arc cam assemblies that provide means to vary the volumetric output of a piston pump by changing the length of its stroke. The inventive cam assemblies use cams that can be infinitely adjusted by changing the position of its hub and therefore its arc. A shorter arc shortens the stroke of the pump. A longer arc lengthens the stroke.

The inventive aspect of the design of the present invention is employing an amplitude adjusting screw that has threads engaging the cam radially and having a head that is captured inside the center of the drive shaft. When the amplitude is adjusted to the desired setting, two clamping screws are tightened within opposing collars and the setting is thus fixed in place. The drive shaft can be keyed to the collars to take up torque. The keys within respective collars can be held therein by small set screws, respectively.

In at least one embodiment, the present invention is directed to a motor driven shaft, wherein the shaft has parallel flat sides, and a cam with an elongated hub bore, two slots on either side of the elongate hub bore, a threaded hole through the radius of the cam and intersecting the elongated hub bore and an adjusting screw inserted into the threaded hole. The cam is connected to the shaft by a set of collars. Screws can be used to attach the cam to the shaft through the slots in the cam. A set of locking screws can also be used to secure the collars to the shaft.

In at least one embodiment, the present invention is directed toward a cam assembly comprising a cam, a drive shaft and an adjustable screw. The cam includes a first side, a second side opposite the first side, an outer perimeter and a thickness between the first and second sides. The cam further has a first elongated bore through the first and second sides and the thickness of the cam, wherein the first elongated bore has a length radially oriented in the cam and a first end and a second end. The cam further has an elongated threaded hole extending from the outer perimeter to and being in communication with the first elongated bore. The drive shaft extends through the first elongated bore. The adjustment screw is within the elongated threaded hole and is engaged with the drive shaft, wherein the cam assembly is constructed and arranged such that the drive shaft can be adjustably positioned and fixedly secured relative to the cam at a plurality of positions along the length of the first elongated bore.

In at least one embodiment, the adjustment screw has a screw head at a first end, wherein the screw head has a radial cross-section perimeter. The radial cross-section perimeter of the screw head is larger than a radial cross-section of the elongated threaded hole. The drive shaft further has a transverse hole for receiving the screw head, such that when the drive shaft is fixedly secured to the cam, the screw head is positioned within the transverse hole in the drive shaft.

In at least one embodiment, the cam assembly can further have a second elongated bore through the first and second sides and the thickness of the cam and a third elongated bore through the first and second sides and the thickness of the cam. The second and third elongated bores radially run parallel to the first elongated bore and the first elongated bore is between the second and third elongated bores. The cam assembly can further have a first clamping screw and a second clamping screw, wherein the first clamping screw extends through the first retaining collar and the second elongated bore and engages the second retaining collar and wherein the second clamping screw extends through the first retaining collar and the third elongated bore and engages the second retaining collar.

In some embodiments, the cam assembly further can have a capturing plug inserted into the second opening of the transverse hole in a manner such that the screw head is trapped within the transverse hole in the drive shaft. The second opening of the transverse hole and the capturing plug are both threaded such that the capturing plug can be screwed into the second opening to secure the screw head in place within the drive shaft.

In at least one embodiment, the invention is directed toward a cam assembly having a plurality of cams, each cam having a first side, a second side opposite the first side, an outer perimeter and a thickness between the first and second sides. Each cam further has a first elongated bore through the first and second sides and the thickness of the cam, wherein the first elongated bore has a length radially oriented in the cam and a first end and a second end. Further, each cam can have an elongated threaded hole extending from the outer perimeter to and being in communication with the first elongated bore, wherein the length of the first elongated bore and the elongated threaded hole are linearly aligned. The cam assembly further includes a drive shaft extending through each of the first elongated bores and a plurality of adjustment screws, one adjustment screw being within the elongated threaded hole of each cam and engaged with the drive shaft. The cam assembly is constructed and arranged such that the drive shaft can be adjustably positioned and fixedly secured relative to each of the cams at a plurality of positions along the length of each first elongated bore. The drive shafts are linearly aligned and each drive shaft is interconnected with an adjacent drive shaft.

In at least one embodiment, the invention is directed toward an adjustable cam for use on a drive shaft. The adjustable cam has a first side, a second side opposite the first side, an outer perimeter and a thickness between the first and second sides. The adjustable cam further has a first elongated bore through the first and second sides and the thickness of the cam, wherein the first elongated bore has a length radially oriented in the adjustable cam and a first end and a second end. The adjustable cam further has an elongated threaded hole extending from the outer perimeter to and being in communication with the first elongated bore, wherein the length of the first elongated bore and the elongated threaded hole are linearly aligned.

The adjustable cam further can have a second elongated bore through the first and second sides and the thickness of the cam and a third elongated bore through the first and second sides and the thickness of the cam, wherein the second and third elongated bores radially run parallel to the first elongated bore and wherein the first elongated bore is between the second and third elongated bores. The adjustable cam can be in combination with an adjustment screw within the elongated threaded hole, wherein the adjustment screw can be adjustably positioned and fixedly secured relative to the cam at a plurality of positions along the length of the first elongated bore.

In at least some embodiments of the present invention, the adjustable cam of the present invention is in combination with a cam carriage within which the cam rotates on a drive shaft. The cam carriage can be engaged with one or more pistons such that the cam's rotating force is translated into a reciprocating force on the pistons. The present invention is further directed to a machine or a device which incorporates the disclosed adjustable cam and cam carriage assembly.

These and other embodiments that characterize the invention are pointed out with particularity in the claims annexed hereto and forming a part hereof However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE DRAWINGS

A detailed description of the invention is hereafter described with specific reference being made to the drawings.

FIG. 1 is a fragmentary perspective view showing of the subject of the invention assembled with a segment of drive shaft.

FIG. 1A is a side view of a retaining collar of the invention.

FIG. 1B is a top view of a retaining collar of the invention.

FIG. 1C is a top view of a retaining collar of the invention.

FIG. 1D is a side view of a retaining collar of the invention.

FIG. 1E is a side view of a retaining collar of the invention with a clamping screw shown therethrough.

FIG. 2 is a simplified diagrammatic front elevational view showing configuration of elements thereof.

FIG. 2A is a side view of an adjustment screw and adjustment screw head of the invention with the adjustment screw head shown as a simplified diagrammatic view.

FIG. 3 is a view of the subject of FIG. 1 in section taken along line 3-3 in FIG. 2.

FIG. 4 is a section taken along line 4-4 in FIG. 3.

FIG. 5 is a fragmentary perspective view similar to that of FIG. 1 with parts in a secondary position.

FIG. 6 is a simplified diagrammatic front elevational view showing configuration of elements in FIG. 5.

FIG. 7 is a view of the subject of FIG. 5 in section taken along line 7-7 in FIG. 6.

FIG. 8 is a section taken along line 8-8 in FIG. 7.

FIG. 9 is a fragmentary perspective view similar to that of FIGS. 1 & 5 with parts in a position intermediate of that shown respectively therein.

FIG. 10 is a perspective view of a prior art cam assembly with multiple aligned cams.

FIG. 11 is a side view showing of the subject of the invention assembled in a carriage and engaged with a piston.

FIG. 12 is a top view of the showing of FIG. 11.

### DETAILED DESCRIPTION OF THE INVENTION

While this invention may be embodied in many different forms, there are described in detail herein specific embodiments of the invention. This description is an exemplification of the principles of the invention and is not intended to limit the invention to the particular embodiments illustrated.

For the purposes of this disclosure, like reference numerals in the Figures shall refer to like features unless otherwise indicated.

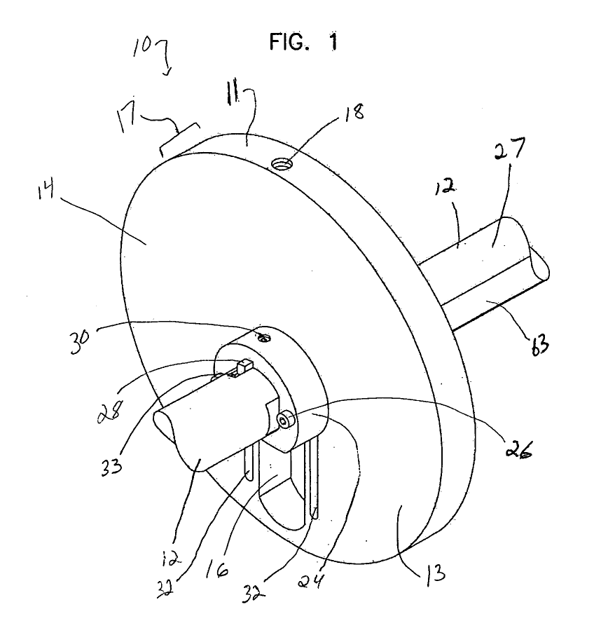

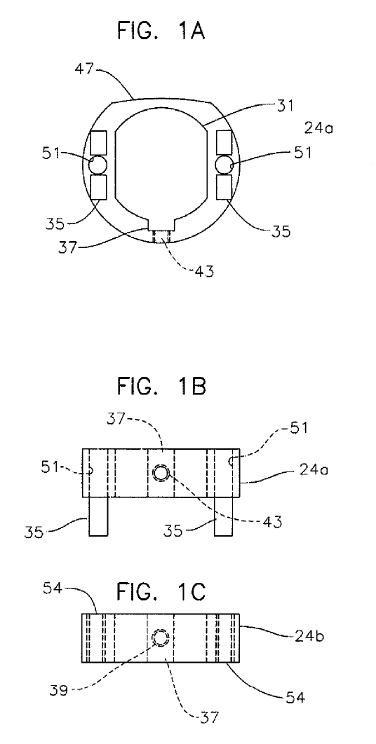

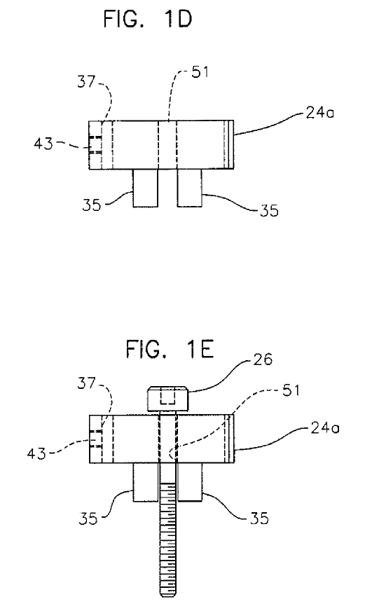

An embodiment of the inventive adjustable arc cam and drive shaft assembly is generally shown at 10 in FIG. 1. The embodiment shown in FIG. 1 includes a cam 14 having a first side 13 and an opposite second side 15 and a thickness 17 defined by the distance between the first side 13 and the second side 15. The cam 14 shown in FIG. 1 also includes a perimeter surface 11 defining the perimeter of the cam 14. In the embodiment shown, the cam 14 has a constant radius; however, the invention contemplates cams being eccentric or having a variable cam profile or a variable radius.

In the embodiment shown, the cam 14 further comprises an elongated bore 16 or drive shaft way 16 transversely oriented through the first side 13 and the second side 15. As better seen in FIG. 4, elongated bore 16 radially extends from a first end 19 centrally positioned in the cam 14 to a second end 21 positioned radially adjacent to the perimeter surface 11, but being separated by a small thickness 23 of the cam material.

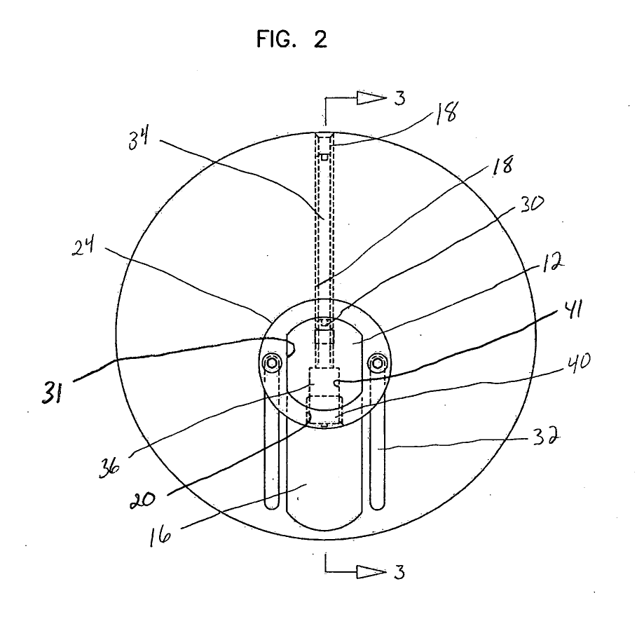

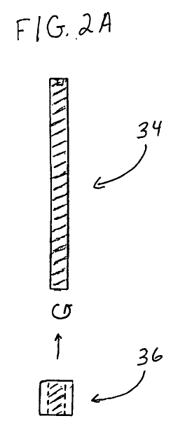

As shown in FIG. 1, the cam further includes an elongated hole 18 radially extending from the perimeter surface 11 to the elongated bore 16. As can be seen in FIG. 2, the elongated hole 18 is linearly aligned with the elongated bore 16. In the embodiment shown, the elongated hole is threaded to receive a threaded adjustment screw 34. The threaded adjustment screw 34 can have a mechanism, such as a socket 38, that can be engaged by the user to drive and adjust the threaded adjustment screw 34 in the threaded elongated hole 18.

In the embodiment shown in FIG. 1, the cam 14 is mounted on a drive shaft 12. In one embodiment, the drive shaft 12 has elongated flat portions (flats) 63 on either side of the drive shaft 12 separated by rounded portions 27. In the embodiment shown, as better shown in FIG. 4, the inner sides 25 and first end 19 of the elongated bore 16 align with the flat portions 63 and one of the rounded portions 27 for a snug fit. It should be understood that the present invention is not limited to the particular inner shape of the elongated bore 16 and the shape of the circumferential perimeter of the drive shaft 12; however the shapes should be such that there is a snug fit between the two such that the drive shaft 12 is sufficiently engaged with the inner surfaces of the elongated bore 16 to effectively rotate the adjustable cam 14.

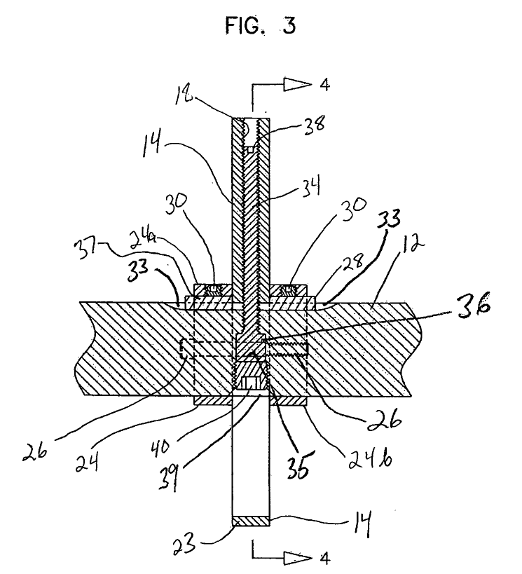

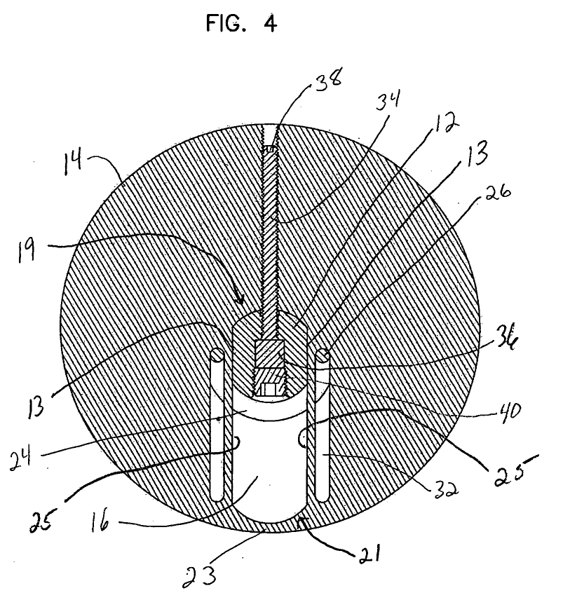

As shown in FIG. 1, in one embodiment, the cam 14 is book-ended by a pair of retaining collars 24 on either side of the cam 14. That being, one of the retaining collars 24a is against the first side 13 of the cam 14 and the other retaining collar 24b (better shown in FIG. 3) is against the second side 15 of the cam 15. The retaining collar 24 is mounted about the drive shaft 12 and, as best shown in FIG. 2, the inner wall 31 of each retaining collar 24 is shaped to closely match the circumferential perimeter of the drive shaft 12.

FIGS. 1A, 1B, 1C, 1D and 1E further illustrate the retaining collars 24a, 24b. Each collar 24a, 24b, includes a threaded hole 43 for receiving a set screw 30 for tightening down on the drive shaft 12, an inner wall 31 to receive the drive shaft 12 and a key way 37 for receiving a key 28 (described below) and can have a flattened bottom portion 47.

The first retaining collar 24a includes through holes 51 for receiving clamping screws 26 as well as tangs 35 to engage elongated bores or slots 32 in the cam 14. The second retaining collar 24b further includes threaded through holes 54 to receive the clamping screws 26. FIG. 1A shows the shape of both retaining collar 24a and 24b. The retaining collars differ in that retaining collar 24a has through holes 51 for the clamping screws 26 and tangs 35, in this embodiment four, for insertion into the elongated bores 32 of the cam 14 and retaining collar 24b includes threaded through holes 54. FIG. 1A shows one side of one of the collars laying flat. Tangs 35 and threaded hole 43 are shown in phantom. FIGS. 1B and 1C show top views of collars 24a and 24b respectively. Through holes 51 and 54 and key ways 37 are shown in phantom. FIG. 1D shows retaining collar 24a from one of its sides. As can be seen in this embodiment, each side includes two tangs 35 separated by a through hole 51. Through holes 51 and 43 and key ways 37 are shown in phantom. FIG. 1E shows the collar as in FIG. 1D with a clamping screw 26 through through hole 51 and between two of the tangs 35. Through holes 51 and 54, part of the clamping screw 26 within the collar 24a and key ways 37 are shown in phantom.

In the embodiment shown, the retaining collars 24 are secured together by the clamping screws 26, which extend from one of the retaining collars 24a through slots or elongated bores 32 in the cam 14 and engage the other retaining collar 24b on the other side of the cam 14. As mentioned above, the retaining collars 24 also can include set screws 30 that can be tightened down in the threaded holes 43 onto keys 28 that are positioned in a key way 33 (a longitudinal groove in the rounded portion 27 of the drive shaft 12) and are positioned between the individual collars 24 and the drive shaft 12.

FIG. 2 is a simplified diagrammatic front elevational view showing configuration of elements thereof. In this view, the cam 14 drive shaft 12 assembly is in its minimum amplitude configuration. It can be seen that the adjustment screw 34 is driven down in the elongated hole 18. At the bottom of the adjustment screw 34 is an adjustment screw head 36 engaged with the adjustment screw 34. FIG. 2A shows the adjustment screw 34 and the adjustment screw head 36. As can be seen, in this particular embodiment, both elements are threaded such that, after the adjustment screw 34 is inserted into the elongated hole 18 and down into the elongated bore 16 and the drive shaft 12, the screw head 36 is screwed onto the end of the elongated screw 34. The adjustment screw head 36 can be bonded to the adjustment screw 34 via suitable means such as weld or silver solder.

As can be seen, the screw head 36 is snuggly positioned within a slot or hole 41 within the drive shaft 12 and the connection between the screw head 36 and the adjustment screw 34 holds the end of the adjustment screw within the drive shaft 12. The cross-sectional or perimeter size of the slot or hole 41 within which the screw head 36 is positioned is greater than the cross-sectional size or perimeter of the threaded hole 18 within which the adjustment screw is positioned. The screw head 36 is in turn secured within the drive shaft 12 and supported by a capturing plug or retaining screw 40 that is driven up from the opposite side of the drive shaft 12 in a threaded hole 39.

FIG. 3 is a view of FIG. 1 in a section taken along line 3-3 in FIG. 2. Although the figure is drawn along the threaded hole 18, the clamping screws 26 are also shown. As can be seen, the clamping screws 26 extend through the cam 14 and clamp the two retaining collars 24 together. Also, it can better be seen in FIG. 3 the key way 33 (a longitudinal groove in the rounded portion 27 of the drive shaft 12) in the drive shaft 12. It can also be seen that keys 28 are positioned in key ways 37 between the retaining collars 24 and set screws 30 and the drive shaft 12. The set screws 30 are driven onto the keys 28, therefore clamping the retaining collars 24 against the drive shaft 12. It can also better be seen that the retaining screw 40 is driven into a threaded hole 39 in the drive shaft 12 to support and secure the adjustment screw head 36 thus capturing it and stabilizing it within the drive shaft 12.

FIG. 4 is a section taken along line 4-4 in FIG. 3. In this figure, the cam 14 is in its minimum amplitude configuration. The drive shaft 12 is at or close to the center of the cam 14 creating a substantially constant arc. The adjustment screw 34 is in its highest position and the head 36 of the adjustment screw 34 is locked into place within the drive shaft 12 by the retaining screw 40.

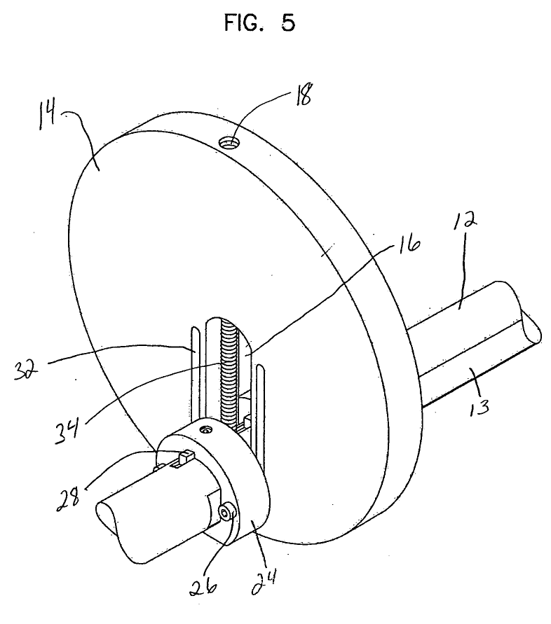

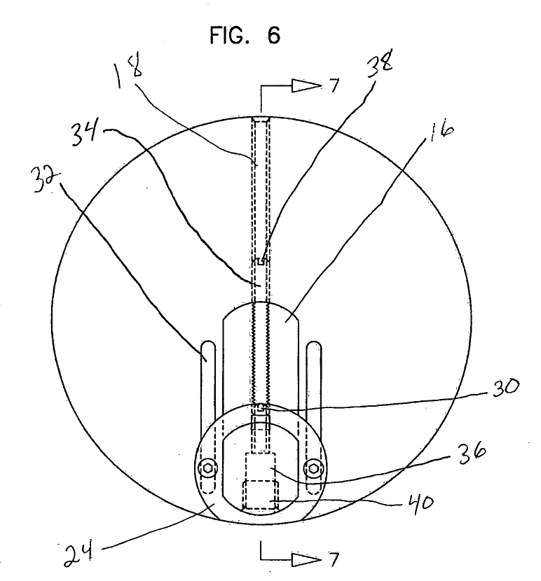

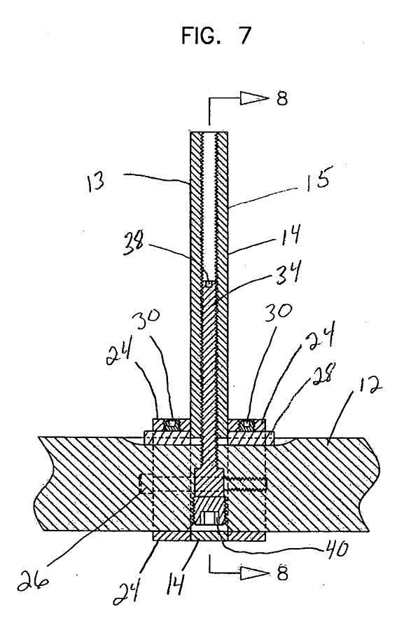

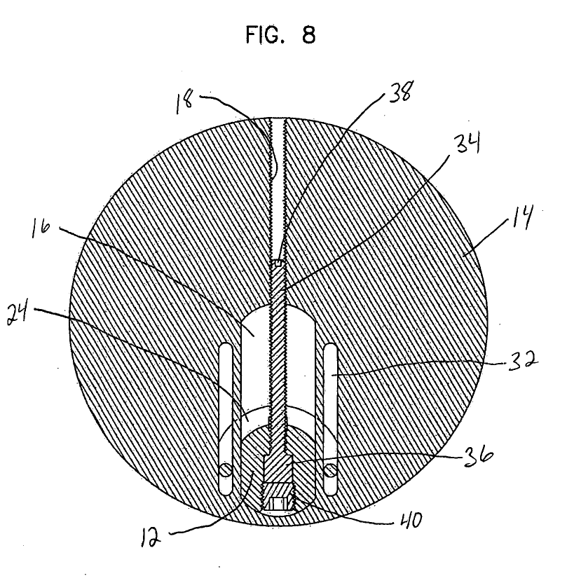

FIGS. 5-8 are same as FIGS. 1-4 except that the cam 14 drive shaft 12 assembly is in its maximum amplitude configuration. FIG. 5 is a fragmentary perspective view similar to that of FIG. 1 with parts in a maximum amplitude configuration. As can be seen, the adjustment screw 34 is driven completely down providing the cam 14 with its maximum arc. FIG. 6 is a simplified diagrammatic front elevational view showing configuration of elements in FIG. 5. FIG. 7 is a view of the subject of FIG. 5 in section taken along line 7-7 in FIG. 6. FIG. 8 is a section taken along line 8-8 in FIG. 7.

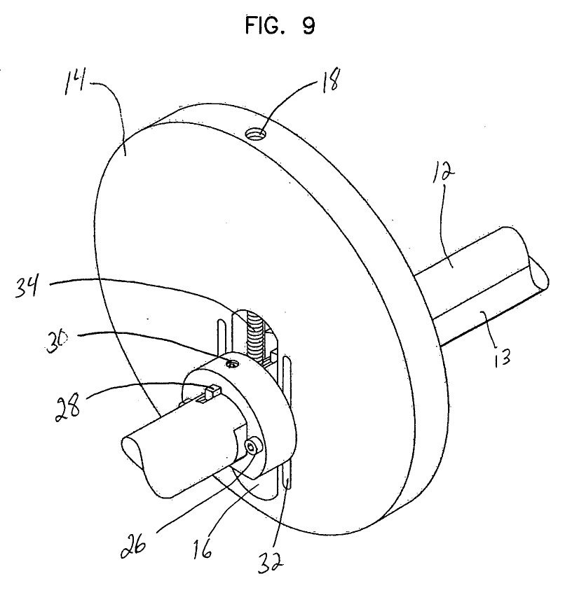

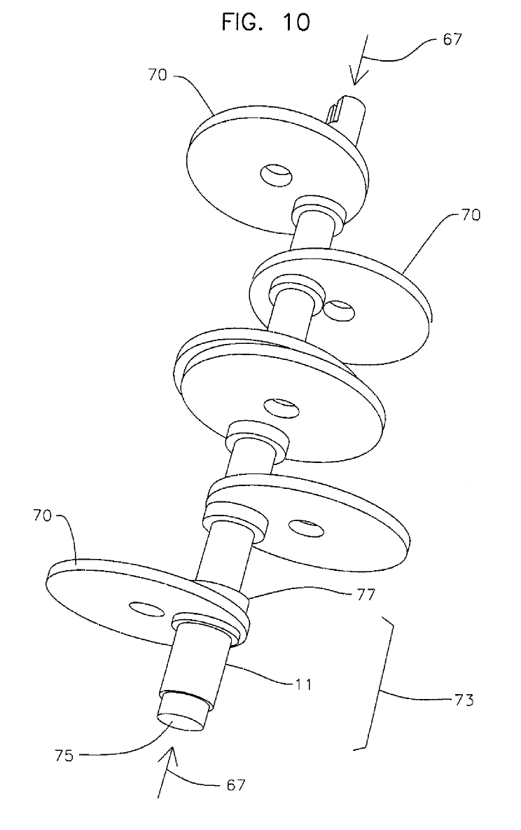

FIG. 9 is a fragmentary perspective view similar to that of FIGS. 1 & 5 with parts in a position intermediate of that shown respectively therein. As demonstrated, the position of the drive shaft 12 within the elongated bore 16 can be manipulated by screwing the adjustment screw 34 down or up. After the desired position has been set, the keys 28, the set screws 30 and the clamping screws 26 are tightened to secure the cam 14 in place on the drive shaft 12.

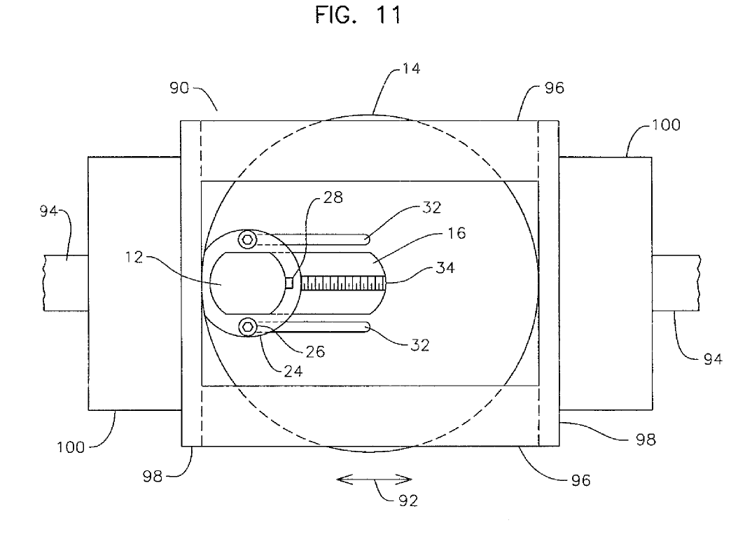

In some embodiments, the cam assembly can include a plurality of the adjustable cams 14 on a single drive shaft 12. To illustrate a multiple cam arrangement, FIG. 10 shows a prior art assembly of non-adjustable cams 70. As shown, the individual cams 70 can vary in their circumferential positioning around the axis 67 of the drive shaft 71. In the assembly shown, each cam 70 is connected to a portion 73 of the drive shaft 71. Each portion 73 can be removed from or connected to the overall drive shaft 71 utilizing male 75 and female 77 parts of the individual portions 73. The present invention utilizes multiple adjustable cam/shaft assemblies 10 (as shown in FIG. 1) linearly aligned and similarly connected or multiple adjustable cams 14 on a single drive shaft 12.

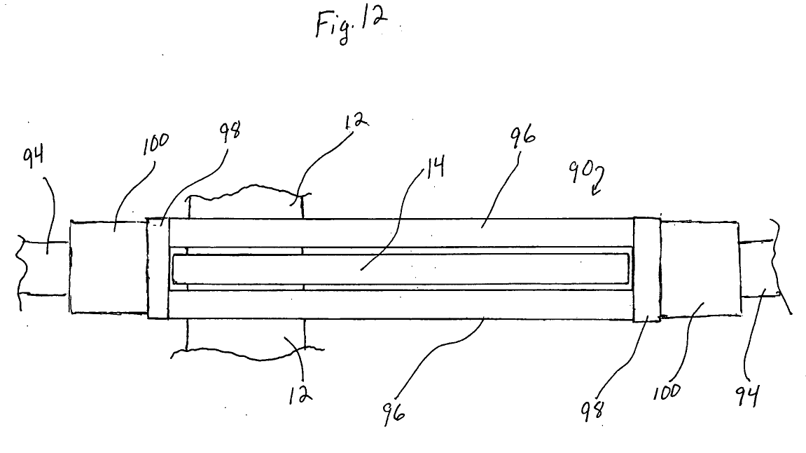

In some embodiments, within systems that utilize piston action, the adjustable cams of the present invention can, individually when multiple cams are used, be positioned within a cam carriage 90 that is in connection with one or more pistons. FIGS. 11 and 12 show a cam 14 within a cam carriage assembly 90. Referring to FIGS. 11 and 12, the cam carriage 90 houses the cam 14, allowing the cam 14 to rotate within it as the cam 14 is driven by the drive shaft 12. As the drive shaft 12 rotates the cam 14, the cam carriage 90 is driven in a reciprocating 92 manner. The carriage 90 is engaged with one or more pistons 94 such that the reciprocating motion 92 of the cam 14 and cam carriage 90 assembly.

In the embodiment shown in FIGS. 11 and 12, the cam carriage 90 forms a sort of “cage” within which the cam 14 can rotate, translating the cam's rotating force into a reciprocating force on the pistons 94. In the particular embodiment shown, the cam carriage 90 includes four connecting bars 96. Plates 98 are at the ends of the connecting bars 96 connecting the bars 96 together to form the holding “cage”. The cam carriage 90 also can include a drive bar 100 which is connected to the cam plate 98 on one side and engages the pistons 94 on the other. It should be understood that the adjustable cam and cam carriage assembly of the present invention can be used in any machine or device that utilizes a reciprocating piston force in its function.

The cam 14 and drive shaft 12 assembly of the present invention can be used in place of non-adjustable cam assemblies in any type of device that utilizes such cams. Devices that utilize a single cam or multiple cams would be readily known to those skilled in the art. Such devices include, but are not limited to, two or more component spraying devices, such as paint spraying devices, and single or multiple component machines which are used to pour or spray substances. Examples of machines which use such cams include machines to meter, mix and dispense polyurethane and/or polyester elastomers, either foamed or un-foamed, epoxies and silicones. Such machines can be obtained from Tobin Manufacturing LLC, located at 370 Alabama Street, Suite L, Redlands, Calif. 92373 (http://www.tobinmanufacturing.com). Such devices may also be obtained from MIZCO, Inc., located at 35311 Cornet Way, Palm Desert, Calif. 92211-3027 (www.mizcoinc.com).

These machines utilize piston pumps to meter plural component, reactive liquids. The piston pumps are powered either directly by an air piston motor through connecting rods and fulcrum or by an electric motor driven shaft connected to a cam or cams Electric motor driven cams can also be used to reciprocate pumps in single or two component spray paint machines. Using the adjustable cams of the present invention to vary the ratios is advantageous when compensating for effects of ambient working conditions or when a different chemical system with a different ratio is required. With the adjustable cams, one can relocate the hub location to produce a different arc and piston stroke, thereby providing a new fixed ratio without having to individually replacing the cams.

A device that utilizes one or more of the present inventive cams typically includes, but is not limited to, a drive motor, a cam shaft, a transfer housing (rectangular box) that the cam(s) rotates within. The transfer housing is typically attached to and communicates with a shaft which in turn is attached to a pump piston that reciprocates in a tube. The pump pumps a liquid reactant through a hose to a dispense valve with multiple inlets which outlet into an attached dynamic or static mixer.

The present invention is also directed methods of adjusting the functioning arc of the above described adjustable cams 14 on the drive shaft 12 without having to remove the cam from the drive shaft on which it is mounted. The methods include adjusting the adjustment screw 34 to a position which corresponds to the desired arc. Prior to adjusting the clamping screws 26 may be loosened to ease movement of the drive shaft 12 within the cam 14 and later tightened after the desired positioning.

The materials of the inventive adjustable cam/drive shaft assemblies include suitable materials including, but not limited to, metals and plastics. Construction techniques will be readily apparent to one skilled in the art.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A cam assembly comprising:
a cam, the cam having a first side, a second side opposite the first side, an outer perimeter and a thickness between the first and second sides, the cam further having a first elongated bore through the first and second sides and the thickness of the cam, wherein the first elongated bore has a length radially oriented in the cam and a first end and a second end, the cam further having an elongated threaded hole extending from the outer perimeter to and being in communication with the first elongated bore, wherein the length of the first elongated bore and the elongated threaded hole are linearly aligned;
a drive shaft extending through the first elongated bore; and
an adjustment screw within the elongated threaded hole and engaged with the drive shaft, wherein the cam assembly is constructed and arranged such that the drive shaft can be adjustably positioned and fixedly secured relative to the cam at a plurality of positions along the length of the first elongated bore.

2. The cam assembly as in claim 1 wherein the adjustment screw comprises a screw head at a first end, the screw head having a radial cross-section perimeter, wherein the radial cross-section perimeter of the screw head is larger than a radial cross-section of the elongated threaded hole and wherein the drive shaft has a transverse hole for receiving the screw head, such that when the drive shaft is fixedly secured to the cam, the screw head is positioned within the transverse hole in the drive shaft.

3. The cam assembly as in claim 1 further comprising a first retaining collar positioned about the drive shaft and against the first side of the cam and a second retaining collar positioned about the drive shaft and against the second side of the cam.

4. The cam assembly as in claim 3 further having a second elongated bore through the first and second sides and the thickness of the cam and a third elongated bore through the first and second sides and the thickness of the cam, wherein the second and third elongated bores radially run parallel to the first elongated bore and wherein the first elongated bore is between the second and third elongated bores.

5. The cam assembly as in claim 4 further comprising a first clamping screw and a second clamping screw, wherein the first clamping screw extends through the first retaining collar and the second elongated bore and engages the second retaining collar and wherein the second clamping screw extends through the first retaining collar and the third elongated bore and engages the second retaining collar.

6. The cam assembly as in claim 2, wherein the transverse hole in the drive shaft and the elongated threaded hole are linearly aligned and wherein the transverse hole in the drive shaft extends entirely through the drive shaft such that it has a first opening receiving the adjustment screw and a second opening opposite the first opening, the cam assembly further comprising a capturing plug inserted into the second opening of the transverse hole in a manner such that the screw head is trapped within the transverse hole in the drive shaft.

7. The cam assembly as in claim 6, wherein the second opening of the transverse hole and the capturing plug are both threaded such that the capturing plug can be screwed into the second opening to secure the screw head in place within the drive shaft.

8. The cam assembly as in claim 3, the first and second retaining collars each comprising a set screw perpendicularly oriented relative to the drive shaft.

9. The cam assembly as in claim 8, wherein the drive shaft further includes a key way, the key way being a longitudinal groove in the drive shaft, wherein the cam assembly further comprises a key positioned within the key way between each of the set screws and the drive shaft, such that the retaining collars can be secured to the drive shaft by driving the set screws down onto the respective keys.

10. The cam assembly as in claim 1, wherein the drive shaft comprises a first elongated flat and a second elongated flat parallel to the first elongated flat and wherein the first elongated bore has a first inner side wall and a second opposing inner side wall parallel to the first inner side wall, the first elongated flat conforming to the first inner side wall and the second elongated flat conforming to the second inner side wall, such that the drive shaft can be adjusted to positions along the length of the first elongated bore.

11. The cam assembly as in claim 1 wherein the outer perimeter of the cam is circular.

12. The cam assembly as in claim 11 wherein the first end of the first elongated bore is centrally located in the cam and the second end of the first elongated bore is located adjacent to the outer perimeter of the cam.

13. A cam assembly comprising:
a plurality of cams, each cam having a first side, a second side opposite the first side, an outer perimeter and a thickness between the first and second sides, each cam further having a first elongated bore through the first and second sides and the thickness of the cam, wherein the first elongated bore has a length radially oriented in the cam and a first end and a second end, each cam further having an elongated threaded hole extending from the outer perimeter to and being in communication with the first elongated bore, wherein the length of the first elongated bore and the elongated threaded hole are linearly aligned;
a drive shaft extending through each of the first elongated bores; and
a plurality of adjustment screws, one adjustment screw being within the elongated threaded hole of each cam and engaged with the drive shaft, wherein the cam assembly is constructed and arranged such the drive shaft can be adjustably positioned and fixedly secured relative to each of the cams at a plurality of positions along the length of each first elongated bore.

14. A plurality of the cam assemblies of claim 1, wherein each of the drive shafts are linearly aligned and wherein each drive shaft is interconnected with an adjacent drive shaft.

15. An adjustable cam for use on a drive shaft, the adjustable cam having a first side, a second side opposite the first side, an outer perimeter and a thickness between the first and second sides, the adjustable cam further having a first elongated bore through the first and second sides and the thickness of the cam, wherein the first elongated bore has a length radially oriented in the adjustable cam and a first end and a second end, the adjustable cam further having an elongated threaded hole extending from the outer perimeter to and being in communication with the first elongated bore, wherein the length of the first elongated bore and the elongated threaded hole are linearly aligned.

16. The adjustable cam of claim 15 further having a second elongated bore through the first and second sides and the thickness of the cam and a third elongated bore through the first and second sides and the thickness of the cam, wherein the second and third elongated bores radially run parallel to the first elongated bore and wherein the first elongated bore is between the second and third elongated bores.

17. The adjustable cam of claim 15 in combination with an adjustment screw within the elongated threaded hole, wherein the adjustment screw can be adjustably positioned and fixedly secured relative to the cam at a plurality of positions along the length of the first elongated bore.

18. A machine having a piston driving mechanism, comprising:
the cam assembly of claim 1;
a piston; and
a cam carriage in communication with the piston, wherein the cam is within the cam carriage and wherein rotation of the cam reciprocatingly drives the carriage and the piston.
